(19) United States
(12) Patent Application Publication
(10) Pub. No.: US 2009/0161340 A1
(43) Pub. Date: Jun. 25, 2009

(54) WHITE LIGHT ILLUMINATOR AND READING LAMP USING THE SAME

(75) Inventors: CHUNG-YUAN HUANG, Santa Clara, CA (US); JER-HAUR KUO, Tu-Cheng (TW); XIN-XIANG ZHA, Shenzhen (CN); LIN YANG, Shenzhen (CN)

Correspondence Address: PCE INDUSTRY, INC.;ATT. Steven Reiss, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/038,821

(22) Filed: Feb. 28, 2008

(30) Foreign Application Priority Data
Dec. 19, 2007 (CN) 200710125260.1

(51) Int. Cl. F21V 9/16

(52) U.S. Cl. 362/84

(57) ABSTRACT

A reading lamp (100) includes a lamp holder (20), a lampshade (30), a bracket (40) connecting the lamp holder with the lampshade, and a white light illuminator (50) received in the lampshade. The white light illuminator includes a light mixer (52) having a light emitting surface (521), and a plurality of light emitting diodes (542) arranged at one side of the light mixer. At least a phosphor layer (523) is disposed on the light emitting surface of the light mixer. Lights emitted by the light emitting diodes enter into the light mixer and spread out of the light mixer from the light emitting surface. The lights spread from the light mixer activate the at least a phosphor layer to emit lights and mix with the light emitted by the at least a phosphor layer thereby obtaining white lights.

### BACKGROUND

1. Technical Field

The present invention relates generally to white light illuminators and reading lamps using the same.

2. Description of Related Art

LEDs (light emitting diodes) is a type of solid state light emitting device and are widely used in daily life, such as in illumination devices or non-emissive display devices, due to its high brightness, long life-span, and wide color gamut.

White LEDs usually include blue LED chips which are capsulated in transparent capsulations doped with yellow phosphors therein. In operation of the white LEDs, blue lights emitted by the blue LED chips activate the yellow phosphors to emit yellow lights. The yellow lights mix with the blue lights to thereby obtain white lights.

In ordinary illuminators, the LEDs usually cooperate with light guide plates so as to convert point light sources generated by the LEDs into to surface light sources. When the white lights generated by the white LEDs pass through the light guide plates, the white lights are dispersed into many kinds of colored lights due to prism effect generated by the light guide plates, which decreases color renditions of white light illuminators. Therefore, there is a need to provide white illuminators having good color renditions.

### SUMMARY

The present invention, in one aspect, provides a white light illuminator having a good color rendition. The white light illuminator includes a light mixer having a light emitting surface, and at least a solid state light emitting element arranged to at least one side of the light mixer. At least a phosphor layer is disposed on the light emitting surface of the light mixer. Lights emitted by the at least a solid state light emitting element enter into the light mixer and spread out of the light mixer from the light emitting surface. The lights spread from the light mixer activate the at least a phosphor layer to emit lights and mix with the light emitted by the at least a phosphor layer thereby obtaining white lights.

The present invention, in another aspect, provides a reading lamp using the white light illuminator. The reading lamp includes a lamp holder, a lampshade, a bracket connecting the lamp holder with the lampshade, and a white light illuminator received in the lampshade. The white light illuminator includes a light mixer having a light emitting surface, and at least a solid state light emitting element arranged to at least one side of the light mixer. At least a phosphor layer is disposed on the light emitting surface of the light mixer. Lights emitted by the at least a solid state light emitting element enter into the light mixer and spread out of the light mixer from the light emitting surface. The lights spread from the light mixer activate the at least a phosphor layer to emit lights and mix with the light emitted by the at least a phosphor layer thereby obtaining white lights.

Other advantages and novel features of the present white light illuminator and reading lamp will become more apparent from the following detailed description of preferred embodiments when taken in conjunction with the accompanying drawings, in which:

### BRIEF DESCRIPTION OF THE DRAWINGS

FIG. 1 is an isometric view of a reading lamp according to a preferred embodiment of the present invention.

FIG. 2 is an exploded view of a portion of the reading lamp of FIG. 1.

FIG. 3 is an exploded, isometric view of a white light illuminator of the reading lamp of FIG. 1

FIG. 4 is an enlarged view of a part of the white light illuminator of FIG. 3, indicated by circle IV thereof.

### DETAILED DESCRIPTION

Reference will now be made to the drawing figures to describe the preferred embodiment in detail.

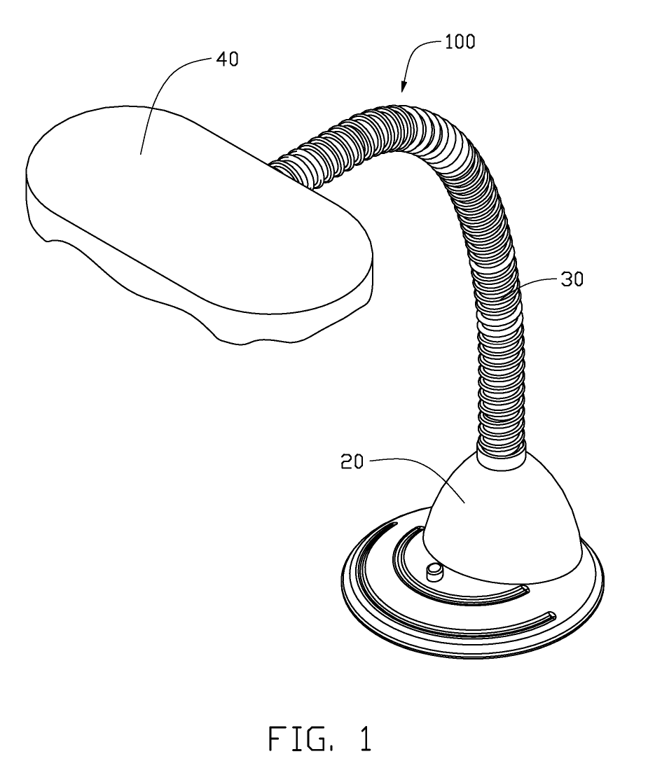

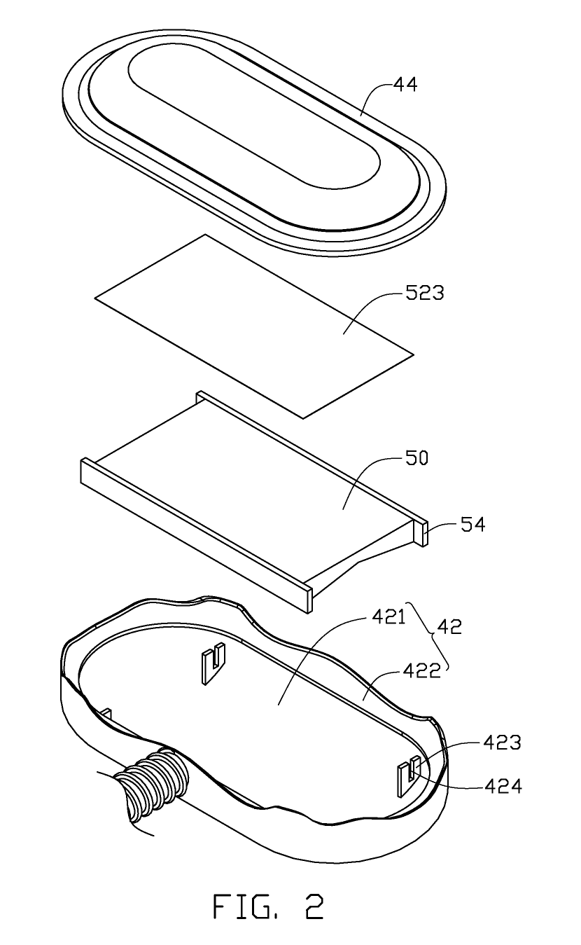

Referring to FIGS. 1 and 2, a reading lamp 100 according to a preferred embodiment of the present invention is shown. The reading lamp 100 includes a lamp holder 20, a bracket 30, a lampshade 40 and a white light illuminator 50.

The lamp holder 20 is disposed at a bottom portion of the reading lamp 100 for mounting the reading lamp 100 on a desktop. The bracket 30 is disposed between the lamp holder 20 and the lampshade 40, supporting the lampshade 40 on the lamp holder 20. The bracket 30 can be used to regulate the lampshade 40 to a desirable height and angle which can help the user to study or work comfortably.

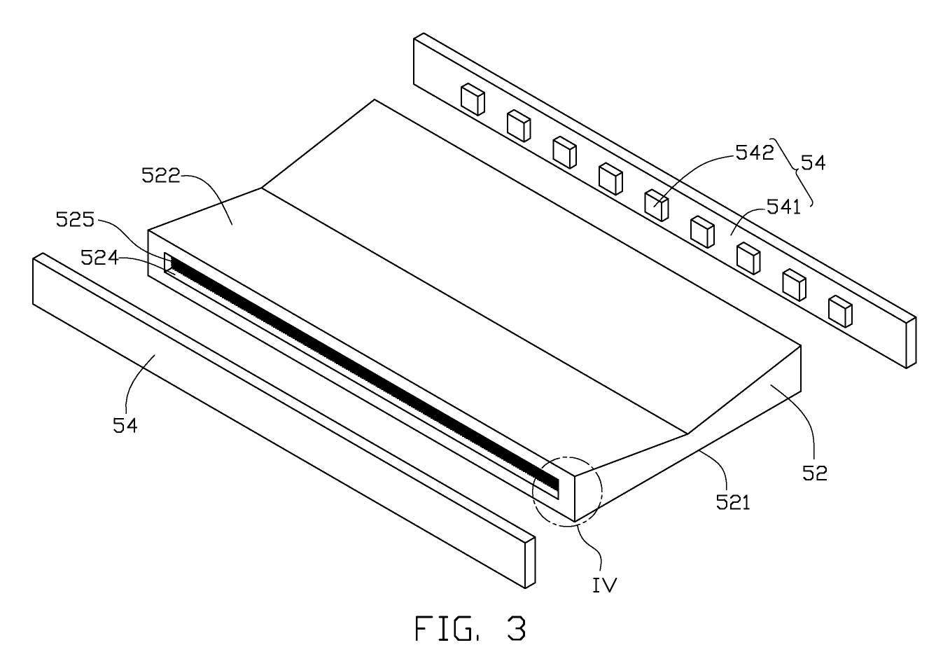

Referring to FIG. 3, the white light illuminator 50 includes a light mixer 52 and two linear-shaped light emitting diode arrays 54.

The light mixer 52 is made of a transparent material such as polymethylmethacrylate (PMMA), or glass. The light mixer 52 includes a planar light emitting surface 521, and a reflecting surface 522 which is opposite to the light emitting surface 521. Referring to FIG. 2, a yellow phosphor layer 523 is adhered to the light emitting surface 521 of the light mixer 52. Alternatively, the yellow phosphor layer 523 can also be coated to the light emitting surface 521.

The reflecting surface 522 of the light mixer 52 is V-shaped in profile. A thickness of the light mixer 52 gradually decreases from right and left sides of the light mixer 52 towards a middle portion thereof. Lights entering into the light mixer 52 from the light emitting diode arrays 54 are refracted and reflected by the reflecting surface 522 and shoot towards the light emitting surface 521 along different directions. The lights are therefore mixed in the light mixer 52 and uniformly distributed over the light emitting surface 521. The V-shaped configuration of the reflecting surface 522 decreases incidence angles of the lights shot from the light diode arrays 54 onto the reflecting surface 522 as compared with a planar reflecting surface. Thus, there are more lights being totally reflected by the reflecting surface 522 towards the light emitting surface 521, which increases luminance of the light spreading from the light emitting surface 521 of the light mixer 52. Alternatively, a reflecting layer (not shown) can be coated on or a plurality of V-shaped tiny grooves (not shown) can be carved in the reflecting surface 522 so as to increase the luminance of the light spreading from the light emitting surface 521 of the light mixer 52.

The light mixer 52 defines two elongated grooves 524 recessed in the right and left sides thereof, respectively. Each of the grooves 524 has a rectangular-shaped transverse section. The light emitting diode arrays 54 are respectively received in the grooves 524 of the light mixer 52, thereby decreasing loss of lights leaked from the light emitting diode arrays 54 without entering the light mixer 52, and thereby increasing luminance of the light spreading from the light emitting surface 521 of the light mixer 52.

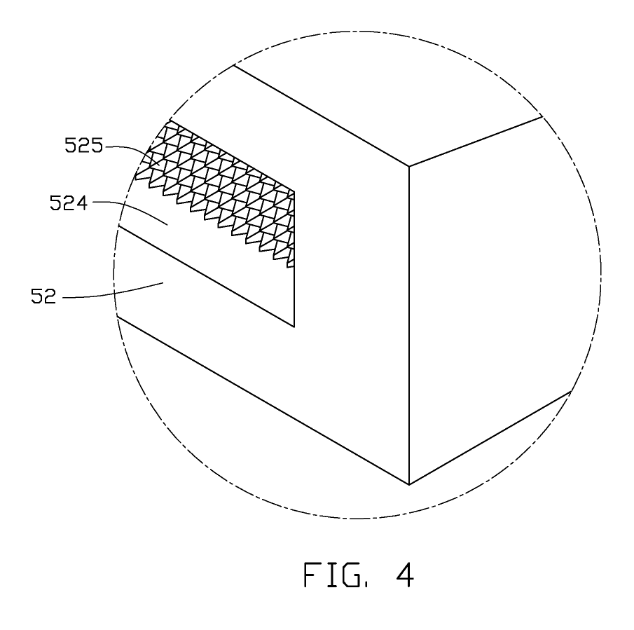

Particularly referring to FIG. 4, a plurality of protruding points 525 are formed on an inner face (not labeled) of the light mixer 52 defining an inner side of each of the grooves 524. The protruding point 525 has a pyramid-shaped configuration and the protruding points 525 are closely packed in the groove 524 so as to induce more light to enter into the light mixer 52. Alternatively, the protruding point 525 may have other configurations such as conical-shaped, or hemispheric-shaped configuration, which may induce more light to enter into the light mixer 52.

Referring to FIG. 3, the light emitting diode array 54 includes an elongate base 541 and a plurality of light emitting diodes 542 (LEDs) mounted to the base 541. Alternatively, the light emitting diodes 542 can be instead by other kinds of solid state light emitting elements such as organic light emitting diodes (OLEDs).

The light emitting diodes 542 are mounted to the light mixer 52 by guiding the bases 541 of the light emitting diode arrays 54 to sidewalls of the light mixer 52 surrounding the grooves 524 of the light mixer 52. The light emitting diodes 544 are received in the grooves 524. A plurality of circuits (not shown) are arranged on the base 541 of the light emitting diode arrays 54. The light emitting diodes 542 of the light emitting diode arrays 54 electrically connected with the circuits and further electrically connected with a power supply (not shown). The base 541 of the light emitting diode array 54 is made of materials having good thermal conductivity such as metals or ceramics so as to dissipate heat generated by the light emitting diodes 542. The base 541 of the light emitting diode array 54 is preferably made of metals such as aluminum, or copper. A layer of electric insulating material (not shown) is coated on outer surfaces of wires of the circuits, thereby electrically insulating the circuits from the bases 541 of the light emitting diode arrays 54, and preventing the circuits from short-circuit.

The light emitting diodes 542 of the light emitting diode arrays 54 are blue light emitting diodes which emit blue lights. In operation of the white light illuminator 50, the light emitting diodes 542 emit blue lights. The blue lights enters into the light mixer 52 through a light incidence surface and are refracted and reflected towards the light emitting surface 521 of the light mixer 52 by the reflecting surface 522. The blue lights spread from the light emitting surface 521 and activate the yellow phosphor layer 523 to emit yellow light and further mix with the yellow light to obtain white lights.

Referring to FIG. 2, the lampshade 40 includes a top cover 42 which connects with the bracket 30 of the reading lamp 100, and a bottom casing 44 which covers a bottom opening of the top cover 42. The top cover 42 includes a top wall 421, a sidewall 422 extending downwardly from a periphery of the top wall 421, and four legs 423 extending downwardly from four corners of the top wall 421. Each of the legs 423 defines a slot 424 which extends through a bottom end of the leg 423. Front and rear ends of the base 541 of the light emitting diode arrays 54 are interferentially engaged in the slots 424 of the legs 423, thereby mounting the white light illuminator 50 to the lampshade 40.

The bottom casing 44 of the lampshade 40 is made of transparent materials such as glass, or epoxy resin. The bottom casing 44 is mounted to the top cover 42 via interferential engagement between a periphery of the bottom casing 44 and an inner surface of the sidewall 422 of the top cover 42. The bottom casing 44 is used for protecting the white light illuminator 50 from being damaged and preventing external dusts from entering into an inner side of the lampshade 40. A middle portion of the bottom casing 44 projects downwardly so that the middle portion of the bottom casing 44 is spaced a distance from the light emitting surface 521 of the white light illuminator 50.

In the present reading lamp 100, the white lights are obtained after the blue lights pass through the light emitting surface 521 of the light mixer 52. When the blue lights pass through the light mixer 52, they can not be dispersed due to blue light is a kind of monochromatic light. Therefore, the present white light illuminator 50 has better color rendition than the conventional white light illuminator 50.

In the present white light illuminator 50, the white lights are obtained from mixtures of the blue lights emitted by the light emitting diodes 542 and the yellow lights emitted by the activated yellow phosphor layer 523. Alternatively, the white lights can be obtained from other mixtures, such as blue lights emitted by blue light emitting diodes and red and green lights emitted by red and green phosphors, or ultraviolet lights emitted by ultraviolet light emitting diodes and red, green and blue lights emitted by red, green and blue phosphors. When there is more than one kind of phosphors, the phosphor layer can be a monolayer containing several kinds of phosphors, or a multilayer comprised by a plurality of stacked layers each of which merely contains one kind of phosphor.

In this embodiment, the white light illuminator 50 is used as a light source of the reading lamp 100. Alternatively, the white light illuminator 50 can be used in other applications, such as backlight modules of liquid crystal displays, light sources of toys, light sources of flashlights, or light sources of indicators.

It is to be understood, how ever, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A white light illuminator comprising:
a light mixer having a light emitting surface;
at least a solid state light emitting element arranged to at least one side of the light mixer; and
at least a phosphor layer disposed on the light emitting surface of the light mixer, wherein lights emitted by the at least a solid state light emitting element enter into the light mixer and spread out of the light mixer from the light emitting surface, the lights spread from the light mixer activate the at least a phosphor layer to emit lights and mix with the light emitted by the at least a phosphor layer thereby obtaining white lights.

2. The white light illuminator of claim 1, wherein a combination of the solid state light emitting element and the phosphor is selected from: combination of blue light emitting diode and yellow phosphor, combination of blue light emitting diode and red and green phosphors, and combination of ultraviolet light emitting diodes and red, green and blue phosphors.

3. The white light illuminator of claim 1, wherein the at least a phosphor layer comprises a layer of phosphor comprising several kinds of phosphors.

4. The white light illuminator of claim 1, wherein the at least a phosphor layer comprises several layers of phosphors, each layer of which comprising one kind of phosphor.

5. The white light illuminator of claim 1, wherein the at least a phosphor layer is coated on or adhered to the light emitting surface of the light mixer.

6. The white light illuminator of claim 1, wherein the light mixer defines at least a groove which receives the at least a solid state light emitting element therein.

7. The white light illuminator of claim 6, wherein a plurality of protruding points are formed on and are closely packed on an inner surface of the light mixer defining the at least a groove.

8. The white light illuminator of claim 7, wherein a configuration of each of the protruding points is selected from a group consisting of pyramid shape, conical shape, and hemispheric shape.

9. The white light illuminator of claim 1, wherein the light mixer has a V-shaped reflecting surface which is opposite to the light emitting surface.

10. The white light illuminator of claim 1, wherein the at least a solid state light emitting element comprises a plurality of solid state light emitting elements which are mounted to a metal base.

11. A reading lamp comprising:
a lamp holder;
a lampshade;
a bracket connecting the lamp holder with the lampshade; and
a white light illuminator received in the lampshade, the white light illuminator comprising:
a light mixer comprising a light emitting surface;
at least a solid state light emitting element arranged to at least one side of the light mixer; and
at least a phosphor layer disposed on the light emitting surface of the light mixer, wherein lights emitted by the at least a solid state light emitting element enter into the light mixer and spread out of the light mixer from the light emitting surface, the lights spread from the light mixer activate the at least a phosphor layer to emit lights and mix with the light emitted by the at least a phosphor layer thereby obtaining white lights.

12. The reading lamp of claim 11, wherein the lampshade comprises four legs each of which defines a slot therein, the white light illuminator comprising a metal base on which the at least a solid state light emitting element is mounted, the white light illuminator being mounted to the lampshade via engagement between the slots of the legs of the lampshade and the metal base of the white light illuminator.

13. The reading lamp of claim 11, wherein a combination of the solid state light emitting element and the phosphor is selected from: combination of blue light emitting diode and yellow phosphor, combination of blue light emitting diode and red and green phosphors, and combination of ultraviolet light emitting diodes and red, green and blue phosphors.

14. The reading lamp of claim 11, wherein the at least a phosphor layer comprises a layer of phosphor comprising several kinds of phosphors.

15. The reading lamp of claim 11, wherein the at least a phosphor layer comprises several layers of phosphors, each layer of which comprising one kind of phosphor.

16. The reading lamp of claim 11, wherein the light mixer defines at least a groove which receives the at least a solid state light emitting element therein, a plurality of protruding points being formed on and are closely packed on an inner surface of the light mixer defining the at least a groove.

17. The reading lamp of claim 16, wherein the light mixer has a V-shaped reflecting surface which is opposite to the light emitting surface.
